(19) United States
(12) Patent Application Publication
(10) Pub. No.: US 2020/0065859 A1
(43) Pub. Date: Feb. 27, 2020

(54) ADVERTISEMENT CONTROL APPARATUS, ADVERTISEMENT SYSTEM, AND ADVERTISEMENT CONTROL METHOD

(71) Applicant: TOYOTA JIDOSHA KABUSHIKI KAISHA, Toyota-shi (JP)

(72) Inventors: Shinji ICHIKAWA, Nagoya-shi (JP); Harunobu SAITO, Nagoya-shi (JP); Daiki KANEICHI, Nisshin-shi (JP); Ryotaro FUJIWARA, Tokyo-to (JP); Megumi AMANO, Toyota-shi (JP); Masato ENDO, Nagakute-shi (JP); Tae SUGIMURA, Miyoshi-shi (JP)

(73) Assignee: TOYOTA JIDOSHA KABUSHIKI KAISHA, Toyota-shi (JP)

(21) Appl. No.: 16/551,911

(22) Filed: Aug. 27, 2019

(30) Foreign Application Priority Data
Aug. 27, 2018 (JP) 2018-158177

(51) Int. Cl. G06Q 30/02

(52) U.S. Cl. CPC G06Q 30/0261; G01C 21/3644

(57) ABSTRACT

A technique is provided, which presents guidance information of a place for a user of a vehicle that is bound for the place indicated by advertisement information. Those executed are display of advertisement information on a display apparatus installed with a display surface directed to a road; acquisition of action information which exhibits an action performed by a crew of a vehicle traveling on the road; judgment to judge whether or not the vehicle is bound for a place indicated by the advertisement information on the basis of the action information; and display of guidance information of the place indicated by the advertisement information on the display apparatus or any display apparatus different from the display apparatus if it is judged that the vehicle is bound for the place indicated by the advertisement information.

### CROSS REFERENCE TO RELATED APPLICATION

This application claims the benefit of Japanese Patent Application No. 2018-158177, filed on Aug. 27, 2018, which is hereby incorporated by reference herein in its entirety.

### BACKGROUND

### Technical Field

The present disclosure relates to an advertisement control apparatus, an advertisement system, and an advertisement control method.

### Description of the Related Art

In Patent Literature 1, the following technique is suggested. That is, it is judged whether or not the winker information, which is provided upon the passage through an intersection, coincides with a connection relationship of an entering link and an exiting link. If it is judged that there is no coincidence, error information is recorded.

### PRIOR ART LITERATURE

### Patent Literature

Patent Literature 1: Japanese Patent Application Laid-Open No. 2009-68873

### SUMMARY

An object of the present disclosure is to provide a technique which presents guidance information of a place for a user of a vehicle that is bound for the place indicated by advertisement information.

A first aspect of the present disclosure resides in an advertisement control apparatus comprising a controller which executes:

display of advertisement information on a display apparatus installed with a display surface directed to a road;

acquisition of action information which exhibits an action performed by a crew of a vehicle traveling on the road;

judgment to judge whether or not the vehicle is bound for a place indicated by the advertisement information on the basis of the action information; and

display of guidance information of the place indicated by the advertisement information on the display apparatus or any display apparatus different from the display apparatus if it is judged that the vehicle is bound for the place indicated by the advertisement information.

A second aspect of the present disclosure resides in an advertisement system comprising an advertisement control apparatus which displays advertisement information on a display apparatus installed with a display surface directed to a road, and a terminal which is provided in a vehicle traveling on the road; the terminal including a controller which executes:

acquisition of action information which exhibits an action performed by a crew of the vehicle; and

transmission of the action information to the advertisement control apparatus; and the advertisement control apparatus including a controller which executes:

display of the advertisement information on the display apparatus;

acquisition of the action information from the terminal;

judgment to judge whether or not the vehicle is bound for a place indicated by the advertisement information on the basis of the action information; and

display of guidance information of the place indicated by the advertisement information on the display apparatus or any display apparatus different from the display apparatus if it is judged that the vehicle is bound for the place indicated by the advertisement information.

A third aspect of the present disclosure resides in an advertisement control method for allowing a controller to execute:

display of advertisement information on a display apparatus installed with a display surface directed to a road;

acquisition of action information which exhibits an action performed by a crew of a vehicle traveling on the road;

judgment to judge whether or not the vehicle is bound for a place indicated by the advertisement information on the basis of the action information; and

display of guidance information of the place indicated by the advertisement information on the display apparatus or any display apparatus different from the display apparatus if it is judged that the vehicle is bound for the place indicated by the advertisement information.

A fourth aspect of the present disclosure resides in an advertisement control program or a computer-readable storage medium which non-transitorily stores the program for allowing a computer to execute:

display of advertisement information on a display apparatus installed with a display surface directed to a road;

acquisition of action information which exhibits an action performed by a crew of a vehicle traveling on the road;

judgment to judge whether or not the vehicle is bound for a place indicated by the advertisement information on the basis of the action information; and

display of guidance information of the place indicated by the advertisement information on the display apparatus or any display apparatus different from the display apparatus if it is judged that the vehicle is bound for the place indicated by the advertisement information.

According to the present disclosure, it is possible to provide the technique which presents the guidance information of the place for the user of the vehicle that is bound for the place indicated by the advertisement information.

### BRIEF DESCRIPTION OF THE DRAWINGS

FIG. 1 shows configuration of an advertisement system according to a first embodiment.

FIG. 2 exemplifies functional configuration of an information processing apparatus.

FIG. 3 shows an exemplary advertisement information table.

FIG. 4 shows a processing procedure of an advertisement control method executed by an advertisement control apparatus.

FIG. 5 shows an exemplary advertisement information table according to a modified embodiment.

FIG. 6 shows an arrangement of display apparatuses and cameras in the modified embodiment.

FIG. 7 shows an advertisement control method according to the modified embodiment.

FIG. 8 shows configuration of an advertisement system according to a second embodiment.

FIG. 9 exemplifies functional configuration of a vehicle onboard apparatus according to the second embodiment.

FIG. 10 exemplifies functional configuration of an advertisement control apparatus according to the second embodiment.

FIG. 11 shows a processing procedure of an advertisement control method executed by the advertisement control apparatus in the second embodiment.

FIG. 12 shows a processing procedure of an advertisement control method executed by the vehicle onboard apparatus in the second embodiment.

### DESCRIPTION OF THE EMBODIMENTS

As digital signages come into widespread use, there are many opportunities to see the digital signages installed along the road when people travel by vehicles. However, the digital signage, which is installed along the road, sends an advertisement merely unilaterally. Any advertisement, which is useful for the crew of the vehicle, is not necessarily displayed.

For example, an advertisement of, for example, a shop or a facility is not such information that is immediately required for the crew who gets on the vehicle for any other purpose such as the commuting to work or the like. Therefore, it is desirable that the advertisement briefly shows, for example, the shop name and the catch phrase to such an extent that the crew grasps the presence of the shop or the facility in the neighborhood. On the contrary, it is desirable that the advertisement shows details to guide, for example, the route and the required time to arrive at the shop or the facility and the presence or absence of the parking space for the crew who sees the advertisement and who is bound for the shop, the facility or the like. However, if the information of all of them is displayed at once, then the advertisement content may become too complicated, and the content cannot be grasped sufficiently from the traveling vehicle. Note that if a digital signage is installed at a position at which the user can operate the digital signage, it is also conceived that an advertisement to be displayed is selected by the user. However, in the case of the digital signage which is installed along the road, it is impossible for the crew of the vehicle to select the advertisement.

Taking the foregoing circumstances into consideration, the embodiment of the present disclosure provides an advertisement control apparatus (computer) which displays guidance information of a place on a digital signage for a user of a vehicle which is judged to be bound for the place indicated by the advertisement information. In the embodiment of the present disclosure, the digital signage is a display apparatus for displaying the advertisement information, which is hereinafter simply referred to as “display apparatus” as well.

The advertisement control apparatus displays the advertisement information on the display apparatus which is installed along the road with the display surface directed to the road, in other words, the display apparatus which performs the display for the crew of the vehicle traveling on the road. In the embodiment of the present disclosure, the vehicle may be any transport means such as passenger cars, buses, taxies and the like on which any person, who is assumed to see the display apparatus, gets to move on the road. For example, the vehicle may include the transport means such as bicycles, motorcycles, and streetcars. Further, in the embodiment of the present disclosure, it is enough that the crew is a person who gets on the vehicle, and the crew is not limited to a driver and a crew member.

The advertisement control apparatus acquires the action information which indicates the action performed by the crew of the vehicle traveling on the road, and the advertisement control apparatus judges whether or not the vehicle is bound for the place indicated by the advertisement information (referred to as “place subjected to the advertisement” or “advertised place” as well) on the basis of the action information. For example, if the crew of the vehicle drives so that the course of the vehicle is changed to be bound for the place indicated by the advertisement information, or if the crew speaks that the vehicle will go to the advertised place, then it is judged that the vehicle is bound for the advertised place.

Then, if it is judged that the vehicle is bound for the advertised place, the advertisement control apparatus displays the guidance information of the advertised place on the display apparatus. In this context, the display apparatus, on which the guidance information is displayed, may be either the same display apparatus as the display apparatus on which the advertisement information is displayed or any distinct display apparatus.

The advertisement information includes various pieces of information such as information of, for example, advertisements of restaurants, amusement facilities and the like, as well as sightseeing information, and information of, for example, warnings and evacuation advisories for disasters (hereinafter referred to as “disaster information” as well). The advertisement information is information for advertising any specified place. Further, the guidance information is information for guiding the advertised place. The guidance information includes, for example, the route and the required time until arrival at the advertised place, the presence or absence of parking space, information relevant to the service provided at the advertised place, and the waiting time until the service is received.

As described above, the advertisement control apparatus of the embodiment of the present disclosure can display the guidance information concerning the advertised place, for the crew of the vehicle which is bound for the advertised place.

### First Embodiment

### (System Outline)

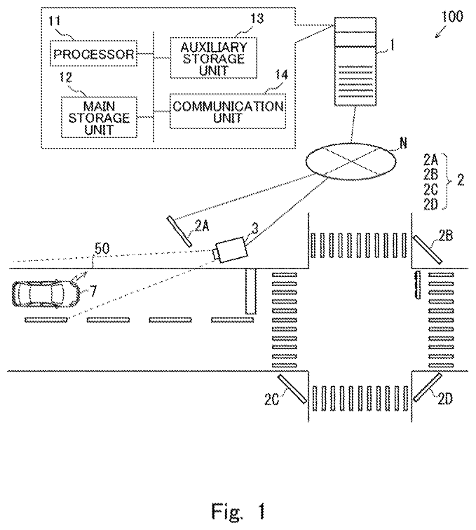

FIG. 1 shows configuration of an advertisement system according to a first embodiment. In the example shown in FIG. 1, the advertisement system 100 is provided with an advertisement control apparatus 1 and a plurality of display apparatuses 2. The advertisement control apparatus 1 displays advertisement information on the display apparatus 2 installed along the road with a display surface directed to the road 50 so that an advertisement is shown with respect to a crew of a vehicle traveling on the road 50. The advertisement control apparatus 1 acquires information (action information) which indicates an action performed by the crew of the vehicle 7 traveling on the road 50. If it is judged that the vehicle 7 is bound for an advertised place, guidance information of the advertised place is displayed on the display apparatus 2. For example, the advertisement control apparatus 1 has a camera 3 for photographing the vehicle 7. The action information of the crew of the vehicle 7 is acquired by analyzing a photographed image photographed by the camera 3.

The communication line N is a wired or wireless communication line. For example, it is also allowable to adopt the public communication network such as the internet or the like or any communication network such as WAN (Wide Area Network) or the like. Further, the communication line N may include the telephone communication network for the mobile phone or the like and the wireless communication network such as Wi-Fi or the like.

### (Apparatus Configuration)

The advertisement control apparatus 1 is composed of, for example, a computer. Such a computer is provided with a processor 11, a main storage unit 12 such as a read only memory (ROM), a random access memory (RAM) and the like, an auxiliary storage unit 13 such as EPROM, a hard disk drive (HDD), removable media and the like, and a communication unit 14 for making communication with the display apparatus 2, the camera 3, and other apparatuses or devices.

The processor 11 is a form of the controller. The processor 11 is also referred to as “CPU”. The processor 11 is not limited to a single processor. The processor 11 may be configured as a multiprocessor. Further, the processor 11 may have multicore configuration.

The auxiliary storage unit 13 stores, for example, an operating system (OS), various programs, and various tables. Further, the auxiliary storage unit 13 of this embodiment stores the advertisement information and an advertisement information table as described later on.

The processor 11 loads the program stored in the auxiliary storage unit 13 to the operation area of the main storage unit 12 to execute the program, and the processor 11 controls, for example, respective configuration units in accordance with the execution of the program. Thus, it is possible to realize respective functional units which achieve predetermined purposes. However, a part or all of the functional units may be realized by a hardware circuit (controller) such as ASIC or FPGA. The advertisement control apparatus 1 is not necessarily constructed by a single computer. The advertisement control apparatus 1 may be constructed by a plurality of computers which are correlated with each other.

### (Functional Configuration)

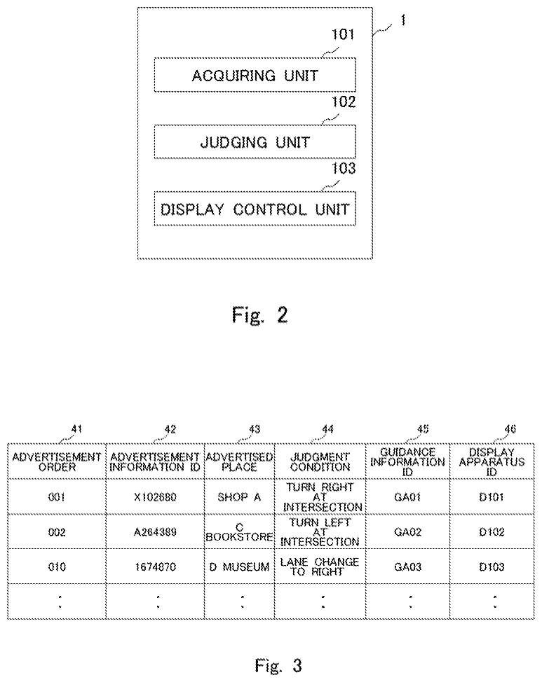

FIG. 2 exemplifies functional configuration of an information processing apparatus. The advertisement control apparatus 1 realizes the functions shown in FIG. 2 by allowing the processor 11 to execute the application program (advertisement control program) stored in the auxiliary storage unit 13. That is, the advertisement control apparatus 1 includes an acquiring unit 101, a judging unit 102, and a display control unit 103.

The acquiring unit 101 acquires the action information which indicates the action performed by the crew of the vehicle 7 traveling on the road 50. In this embodiment, those acquired as the action information includes information of, for example, the direction to indicate the traveling situation of the vehicle 7 brought about by the execution of the action (operation or driving) of, for example, the operation of a direction indicator of the vehicle 7 by the crew, the decrease in the vehicle speed, and the change of the lane.

The judging unit 102 judges whether or not the vehicle 7 is bound for the advertised place on the basis of the action information acquired by the acquiring unit 101. For example, the judgment condition, which is usable to judge whether or not the vehicle 7 is bound for the advertised place, is set beforehand for every piece of the advertisement information. If the traveling situation of the vehicle 7 fulfills the judgment condition, it is judged that the vehicle 7 is bound for the advertised place. A specified judgment technique will be described later on.

If it is judged by the judging unit 102 that the vehicle 7 is bound for the advertised place, the display control unit 103 displays the guidance information of the advertised place on the display apparatus 2. For example, the advertisement information and the guidance information of the advertised place are registered beforehand in an advertisement information table while being correlated with each other. The display control unit 103 specifies the guidance information of the advertised place by making reference to the advertisement information table, and the guidance information of the advertised place is displayed on the display apparatus 2.

FIG. 3 shows an exemplary advertisement information table. Note that in FIG. 3, the values of the respective items are shown by a language used by the person, for the convenience of explanation. However, it is also allowable to use any form which can be processed by the advertisement control apparatus 1. For example, the values may be shown by binary data. In the example shown in FIG. 3, the advertisement order 41 to indicate the order for displaying the advertisement information, the identification information (advertisement information ID) 42 of the advertisement information, the advertised place 43, the judgment condition 44 to judge whether or not the vehicle 7 is bound for the advertised place 43, the identification information (guidance information ID) 45 of the guidance information for guiding the advertised place 43, and the identification information (display apparatus ID) 46 of the display apparatus 2 for displaying the guidance information are stored while being correlated with each other.

### (Advertisement Control Method)

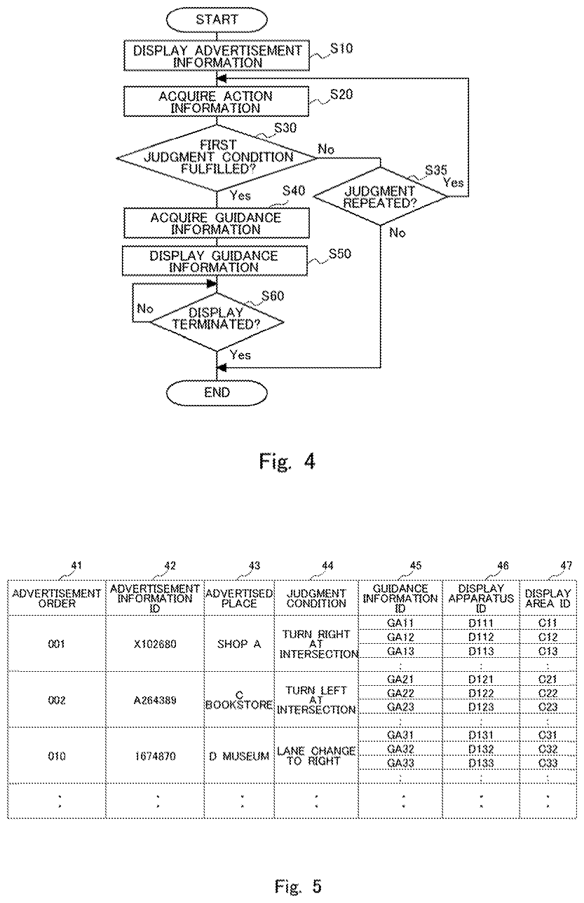

FIG. 4 shows a processing procedure of an advertisement control method executed by the advertisement control apparatus 1. The process shown in FIG. 4 is started taking the opportunity of, for example, the turning on of the power source of the advertisement control apparatus 1 or the execution of the operation for starting the process by an administrator of the advertisement control apparatus 1.

In Step S10, the advertisement control apparatus 1 transmits the advertisement information via the communication line N to the display apparatus 2 installed with the display surface directed to the road 50 so that the advertisement information is displayed. For example, the advertisement control apparatus 1 makes reference to the advertisement information table to acquire the advertisement information ID in a predetermined order (advertisement order), and the advertisement control apparatus 1 reads the advertisement information specified by the advertisement information ID from the auxiliary storage unit 13 to transmit the advertisement information to the display apparatus 2 so that the advertisement information is displayed.

In Step S20, the advertisement control apparatus 1 acquires the traveling situation of the vehicle 7 traveling on the road 50, as the action information. For example, the image of the vehicle 7 is extracted from the photographed image photographed by the camera 3, by means of the pattern matching to acquire the information which indicates, for example, the direction indicated by the direction indicator of the vehicle 7, the traveling speed (vehicle speed) of the vehicle 7, and/or the lane on which the vehicle 7 travels. Specifically, if any orange light is blinking at a left portion or a right portion of the vehicle 7 in the image of the vehicle 7, the advertisement control apparatus 1 acquires the traveling situation as the information of the direction indicator to indicate that the vehicle 7 will turn left or turn right in the blinking direction. Further, the vehicle speed of the vehicle 7 is calculated from the distance by which the image of the vehicle 7 advances in a predetermined time in the photographed image. Further, if the road 50 has a plurality of lanes on one side, the advertisement control apparatus 1 acquires the information which indicates that on which lane of the plurality of lanes the image of the vehicle 7 is positioned, i.e., on which lane the vehicle 7 travels. In this case, it is also allowable to acquire the information which indicates whether or not the cruising lane is changed within a predetermined period after the display of the advertisement information. Further, the attribute information, which indicates the positions of, for example, the exclusive right-turn lane and the exclusive left-turn lane, may be acquired for the road 50. It is also allowable to acquire the information which indicates that the vehicle 7 performs the lane change to the exclusive right-turn lane or the vehicle 7 performs the lane change to the exclusive left-turn lane.

In Step S30, the advertisement control apparatus 1 judges whether or not the vehicle 7 is bound for the advertised place on the basis of the traveling situation (action information) acquired in Step S20. For example, the advertisement control apparatus 1 makes reference to the advertisement information table to find or determine the judgment condition corresponding to the advertisement information displayed in Step S10, and the advertisement control apparatus 1 judges whether or not the traveling situation acquired in Step S20 fulfills the judgment condition. Specifically, the direction indicated by the direction indicator of the vehicle 7 is acquired as the action information. If the direction indicated by the direction indicator is coincident with the direction which is directed to the place (for example, Shop A) indicated by the advertisement information from the present position of the vehicle, it is judged that the judgment condition is fulfilled (affirmative judgment). If the direction indicated by the direction indicator is not coincident with the direction which is directed to the place (for example, Shop A) indicated by the advertisement information from the present position of the vehicle, it is judged that the judgment condition is not fulfilled (negative judgment).

If the negative judgment is made in Step S30, the advertisement control apparatus 1 proceeds to Step S35 to judge whether or not the judgment of Step S30 is repeated. For example, if the elapsed time from the point in time at which the advertisement information is displayed in Step S10 is less than a predetermined value, or if the number of times of repetition in Step S30 is less than a predetermined value, then it is judged that the process of Step S30 is to be repeated (affirmative judgment). On the other hand, if the elapsed time is not less than the predetermined value, or if the number of times of repetition in Step S30 is not less than the predetermined value, then it is judged that the process of Step S30 is not to be repeated (negative judgment), and the process shown in FIG. 4 is terminated.

If the affirmative judgment is made in Step S30, then the advertisement control apparatus 1 proceeds to Step S40 to find or determine the guidance information ID corresponding to the advertisement information displayed in Step S10 from the advertisement information table, and the advertisement information specified by the advertisement information ID is acquired from the auxiliary storage unit 13.

In Step S50, the advertisement control apparatus 1 transmits the advertisement information acquired in Step S40 to the display apparatus 2 so that the advertisement information is displayed. The advertisement control apparatus 1 of this embodiment makes reference to the advertisement information table to acquire the display apparatus ID 46 of the display apparatus 2 on which the guidance information is to be displayed, and the advertisement control apparatus 1 displays the guidance information on the display apparatus 2 specified by the display apparatus ID 46. For example, the guidance information is displayed on the display apparatus 2D which is set in the advertisement information table and which is included in the display apparatuses 2A to 2D controlled by the advertisement control apparatus 1 as shown in FIG. 1. Accordingly, for example, if the vehicle 7 is bound for the place indicated in the advertisement information, then the guidance information is displayed on only the display apparatus 2D installed at the position at which the display apparatus 2D is seen from the vehicle 7 with ease, and the guidance information is not displayed on the other display apparatuses 2A to 2C to continue the display of the advertisement information displayed in Step S10. That is, the display area, in which the guidance information is displayed, can be limited to a range which is the display target of the display apparatus 2D. In this way, in this embodiment, the display apparatus subjected to the display is decided for every piece of the guidance information, and the display area of the guidance information is decided thereby.

Note that it is not necessarily indispensable that the guidance information is displayed on only the display apparatus 2 indicated by the display apparatus ID. For example, the guidance information may be displayed on all of the display apparatuses 2A to 2D controlled by the advertisement control apparatus 1. In this case, it is also allowable to omit the registration of the display apparatus ID in the guidance information table.

In Step S60, the advertisement control apparatus 1 judges whether or not the display of the guidance information is terminated. For example, if a predetermined times elapses after the start of the display of the guidance information, it is judged that the display is terminated.

If the affirmative judgment is made in Step S60, the advertisement control apparatus 1 terminates the process shown in FIG. 4. Note that the advertisement control apparatus 1 repeatedly executes the process shown in FIG. 4, until the power source is shut off, or until the stop operation is performed by the administrator. Further, when the advertisement control apparatus 1 repeats the process shown in FIG. 4 to display the advertisement information in Step S10, then the advertisement information, which is next to the advertisement information having been displayed in the previous process, is acquired on the basis of the advertisement order of the advertisement information table, and the advertisement information is displayed in turns.

### (Function and Effect)

The advertisement control apparatus 1 of this embodiment acquires the traveling situation of the vehicle 7 as the action information. The advertisement control apparatus 1 judges whether or not the vehicle 7 is bound for the place indicated in the advertisement information on the basis of the action information (traveling situation). If it is judged that the vehicle 7 is bound for the advertised place, the guidance information is displayed on the display apparatus 2. Therefore, it is possible to precisely display the guidance information for the crew of the vehicle which is bound for the advertised place.

For example, the advertisement control apparatus 1 displays the brief information such as “turn right at traffic signal” or the like to indicate the place of the shop or the like, together with the shop name and the catch phrase as the advertisement information. The crew of the vehicle 7 sees, for example, the advertisement information, and the crew of the vehicle 7 operates the direction indicator to give the sign to turn to the right in order that the vehicle 7 is bound for the advertised place. In this case, the advertisement control apparatus 1 acquires the information of the direction indicator from the photographed image obtained by the camera 3. If the information of the direction indicator is coincident with the direction directed to the advertised place, and the judgment condition is fulfilled, then it is judged that the vehicle 7 is bound for the advertised place, and the detailed guidance information, which includes, for example, the map for indicating the route until arrival at the advertised place, the required time, and the situation of parking space vacancy, is displayed.

Accordingly, the advertisement control apparatus 1 of this embodiment is operated such that the advertisement information, which is displayed for the crew of the general vehicle traveling on the road, is provided as the brief information which can be easily grasped, while the guidance information, which is displayed for the crew of the vehicle bound for the advertised place, is provided as the detailed information. It is possible to provide the appropriate information depending on the situation. Further, for the crew of the vehicle which is bound for the advertised place, it is possible to obtain the guidance information of the advertised place even if any navigation apparatus is not available. The convenience is improved when the vehicle is bound for the advertised place.

### Modified Embodiment

The embodiment described above is illustrative of such an exemplary case that one piece of the guidance information is displayed for one advertised place 43 indicated by the advertisement information. However, there is no limitation thereto. In this modified embodiment, a plurality of pieces of guidance information are displayed for one advertised place 43. The configuration other than the above is the same as that of the embodiment described above. Therefore, any duplicate explanation will be omitted, for example, by designating the same elements by the same reference numerals.

FIG. 5 shows an exemplary advertisement information table according to the modified embodiment. As shown in FIG. 5, the advertisement information table of this modified embodiment stores a plurality of guidance information ID's 45, a plurality of display apparatus ID's 46, and a plurality of display area ID's 47 for one advertised place 43 while being correlated with each other. The display area ID 47 is the information to identify or distinguish the display area. The display area is the area which is usable as the display target by the display apparatus 2. In other words, the display area is the area in which the crew of the vehicle 7 can see the advertisement information and the guidance information displayed on the display apparatus 2. The display area is, for example, a predetermined range ranging from the position of installation of the display apparatus 2, a predetermined range ranging from the intersection indicated by a node number of the map information, and/or a predetermined range of the road indicated by a link number of the map information. In this modified embodiment, the cameras 3, which photograph the display areas of the respective display apparatuses 2 respectively, are provided. The photographing ranges of the respective cameras 3 are allowed to correspond to the respective display areas. That is, the ranges photographed by the cameras 3 are the display areas. Then, the pieces of identification information of the cameras 3 are used as the display area ID's.

Further, in this modified embodiment, the advertisement information table stores the advertisement information specified by the advertisement information ID, the plurality of display apparatuses 2 installed at different positions on the route from the display area of the advertisement information to the advertised place 43 indicated by the advertisement information, and the display areas of the display apparatuses while being correlated with each other. In this way, in this modified embodiment, the plurality of display areas are set on the route while providing the mutually different areas.

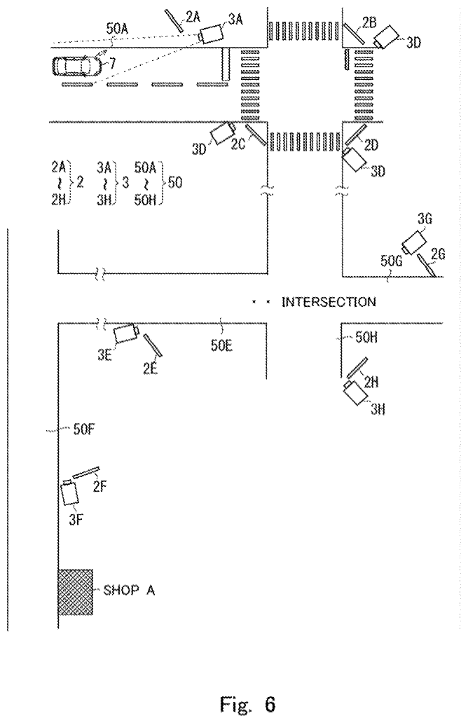

FIG. 6 shows an arrangement of the display apparatuses 2 and the cameras 3 in the modified embodiment. As shown in FIG. 6, in this modified embodiment, the display apparatuses 2A to 2H and the cameras 3A to 3H are provided respectively for the plurality of roads 50A to 50H. The respective display apparatuses 2A to 2H are arranged along the roads with the display surfaces directed to the respective roads 50A to 50H to display the advertisement information or the guidance information with respect to the crews of the vehicles 7 traveling on the respective roads. Further, the respective cameras 3A to 3H photograph the vehicles 7 traveling on the respective roads 50A to 50H.

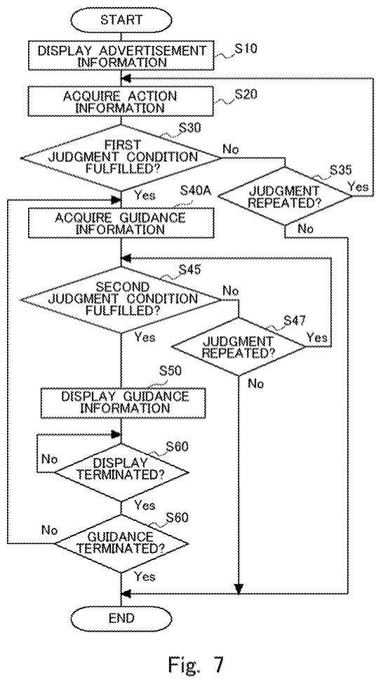

FIG. 7 shows an advertisement control method according to this modified embodiment. Note that the processes from the start to Step S35 shown in FIG. 7 are the same as those shown in FIG. 4 described above. In this modified embodiment, the judgment condition of Step S30 is the condition to judge whether or not the process (Steps S40A to S70) for displaying the plurality of pieces of the guidance information is executed, and the judgment condition of Step S30 is hereinafter referred to as “first judgment condition” as well.

If the affirmative judgment is made in Step S30, then the advertisement control apparatus 1 proceeds to Step S40A to select one guidance information ID in a predetermined order from the plurality of guidance information ID's corresponding to the advertisement information displayed in Step S10, and the guidance information, which is specified by the guidance information ID, is read and acquired from the auxiliary storage unit 13.

In Step S45, the advertisement control apparatus 1 makes reference to the advertisement information table to acquire the display area ID corresponding to the guidance information acquired in Step S40A. The advertisement control apparatus 1 makes the judgment based on whether or not the vehicle 7 arrives at the display area specified by the display area ID, as the second judgment condition. In this procedure, in order to judge whether or not the vehicle 7 arrives at the display area, for example, it is judged whether or not the vehicle 7 is bound for the advertised place and the vehicle 7 arrives at the area at which it is possible to see the guidance information displayed on the display apparatus 2 specified by the display apparatus ID. In this modified embodiment, the roads 50D to 50H, which are the display targets of the display apparatus 2D to 2H, are photographed by the cameras 3D to 3H. If the image of the same vehicle 7 as the vehicle 7 judged to be bound for the advertised place in Step S30 is extracted from the photographed images, it is judged that the vehicle 7 arrives at the display area (affirmative judgment).

If the negative judgment is made in Step S45, the advertisement control apparatus 1 proceeds to Step S47 to judge whether or not the judgment of Step S45 is repeated. For example, if the elapsed time from the point in time at which the guidance information is acquired in Step S40A is less than a predetermined value, and/or if the number of times of repetition of Step S45 is less than a predetermined value, then it is judged that the process of Step S45 is repeated (affirmative judgment). On the other hand, if the elapsed time is not less than the predetermined value, and/or if the number of times of repetition of Step S30 is not less than the predetermined value, then it is judged that the process of Step S45 is not repeated (negative judgment), and the process shown in FIG. 7 is terminated.

On the other hand, if the affirmative judgment is made in Step S45, then the advertisement control apparatus 1 proceeds to Step S50 to acquire the display apparatus ID corresponding to the guidance information acquired in Step S40A by making reference to the advertisement information table, and the guidance information is transmitted to the display apparatus 2 specified by the display apparatus ID so that the guidance information is displayed. In Step S60, the advertisement control apparatus 1 judges whether or not the display of the guidance information displayed in Step S50 is terminated. For example, if a predetermined time elapses after the start of the display of the guidance information, it is judged that the display is terminated.

If the affirmative judgment is made in Step S60, the advertisement control apparatus 1 proceeds to Step S70 to judge whether or not the display of the guidance information corresponding to the advertisement information displayed in Step S10 is entirely completed. If the negative judgment is made in Step S70, i.e., if any guidance information to be displayed remains, then the advertisement control apparatus 1 returns to Step S40A to successively acquire the guidance information which is not displayed yet, and the following processes are repeated.

Then, if the affirmative judgment is made in Step S70, the advertisement control apparatus 1 terminates the process shown in FIG. 7. Note that the advertisement control apparatus 1 repeatedly executes the process shown in FIG. 7 until the power source is shut off, or until the stop operation is performed by the administrator.

As described above, the advertisement control apparatus 1 of this modified embodiment successively displays the plurality of pieces of the guidance information. For example, the advertisement control apparatus 1 displays the advertisement information such as “Shop A, turn right at traffic signal” or the like on the display apparatuses 2A to 2H (FIG. 6) (Step S10). If the vehicle 7 gives a sign to turn right on the road 50A, it is judged that the vehicle 7 is bound for the advertised place (Shop A) (Step S30, Yes). Then, the advertisement control apparatus 1 displays a map to indicate the route until arrival at Shop A and a message to indicate the route until arrival at the next junction such as “go straight on for 500 m and turn right at ** intersection” as the guidance information GA11 on the display apparatus 2D.

If the vehicle 7 turns right at ** intersection and travels until the road 50E, then the advertisement control apparatus 1 judges that the vehicle 7 arrives at the display area of the display apparatus 2E on the basis of the photographed image of the camera 3E (Step S45, Yes), and the next guidance information GA12 is displayed on the display apparatus 2E. The guidance information GA12 is, for example, a message to indicate the route until arrival at the further next junction, such as “300 m ahead, turn left at T junction”.

Then, if the vehicle 7 travels to the road 50F, then the advertisement control apparatus 1 judges that the vehicle 7 arrives at the display area of the display apparatus 2F on the basis of the photographed image of the camera 3F (Step S45, Yes), and the next guidance information GA13 is displayed on the display apparatus 2F. As for the guidance information GA13, for example, a message to indicate the route until arrival at Shop A, such as “50 m ahead, red building on left side is Shop A” is displayed on the display apparatus 2F.

As described above, according to this modified embodiment, the guidance information can be successively displayed depending on the traveling position of the vehicle 7. It is possible to make the guidance comprehensively until arrival at the advertised place (Shop A in the example shown in FIG. 6). Therefore, even if the vehicle 7 is not provided with any navigation apparatus, the crew of the vehicle 7 can easily drive until arrival at the advertised place.

### Second Embodiment

The first embodiment and the modified embodiment described above are configured such that the advertisement control apparatus 1 acquires the action information from the photographed image of the camera 3. However, there is no limitation thereto. It is also possible to adopt such configuration that the action information of the crew is acquired from the vehicle 7. In a second embodiment, the vehicle 7 is provided with a vehicle onboard apparatus (terminal) 70, and an advertisement control apparatus 1A acquires the action information from the vehicle onboard apparatus 70. Note that the configuration other than the above is the same as that of the modified embodiment described above. Therefore, for example, the same elements are designated by the same reference numerals, and any duplicate explanation will be omitted.

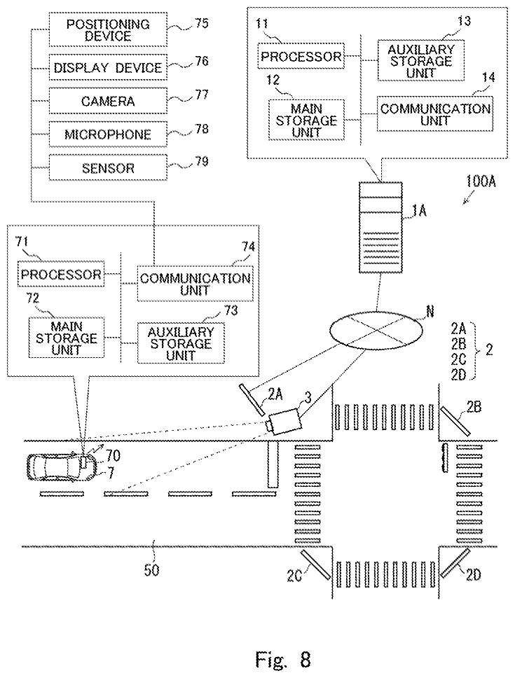

FIG. 8 shows configuration of an advertisement system according to the second embodiment. In the example shown in FIG. 8, the advertisement system 100A is provided with an advertisement control apparatus 1A, a plurality of display apparatuses 2, and the vehicle onboard apparatus 70. The vehicle onboard apparatus 70 deals with the vehicle speed of the vehicle 7, the information of the direction indicator, and the position information as well as the information of, for example, the direction of the line of sight, the action, and the voice of the crew as the action information which is transmitted to the advertisement control apparatus 1A.

The advertisement control apparatus 1A displays the advertisement information on the display apparatus 2 which is installed along the road with the display surface directed to the road 50, and the advertisement is presented with respect to the crew of the vehicle traveling on the road 50. Further, the advertisement control apparatus 1A acquires, from the vehicle onboard apparatus 70, the information (action information) which indicates the action performed by the crew of the vehicle 7 traveling on the road 50. If it is judged that the vehicle 7 is bound for the advertised place, the guidance information of the advertised place is displayed on the display apparatus 2 or a display device provided for the vehicle onboard apparatus.

### (Apparatus Configuration)

The vehicle onboard apparatus 70 is composed of, for example, a computer. Such a computer is provided with a processor 71, a main storage unit 72, an auxiliary storage unit 73, and a communication unit 74. The main storage unit 72 has, for example, a read only memory (ROM) and a random access memory (RAM). The auxiliary storage unit 73 has, for example, EPROM, hard disk drive (HDD), SSD (solid state drive), and removable media. The communication unit 74 is a communication interface for making communication with a positioning device 75, a display device 76, a camera 77, a microphone 78, a sensor 79, and other apparatuses or devices.

The processor 71 is a form of the control unit. The processor 71 is also referred to as “CPU”. The processor 71 is not limited to a single processor. The processor 71 may be configured as a multiprocessor. Further, the processor 71 may have multicore configuration.

The auxiliary storage unit 73 stores, for example, an operating system (OS), various programs, and various tables.

The processor 71 loads the program stored in the auxiliary storage unit 73 to the operation area of the main storage unit 72 to execute the program, and the processor 71 controls, for example, respective configuration units in accordance with the execution of the program. Thus, it is possible to realize respective functional units which achieve predetermined purposes. However, a part or all of the functional units may be realized by a hardware circuit (controller) such as ASIC or FPGA. The vehicle onboard apparatus 70 is not necessarily constructed by a single computer. The vehicle onboard apparatus 70 may be constructed by a plurality of computers which are correlated with each other.

### (Functional Configuration)

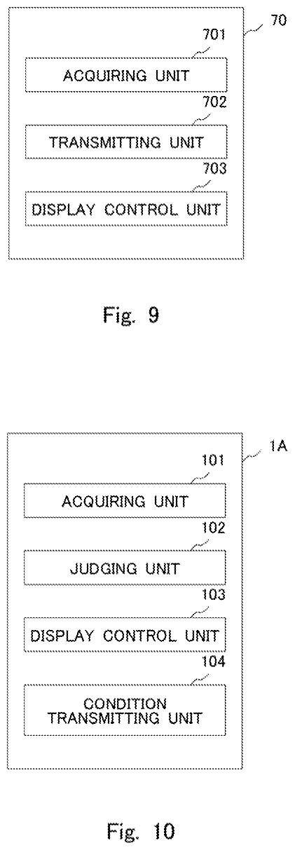

FIG. 9 exemplifies functional configuration of the vehicle onboard apparatus 70. The vehicle onboard apparatus 70 realizes the functional units shown in FIG. 9 by allowing the processor 71 to execute the application program stored in the auxiliary storage unit 73. That is, the vehicle onboard apparatus 70 includes an acquiring unit 701, a transmitting unit 702, and a display control unit 703.

The acquiring unit 701 acquires the action information which indicates the action performed by the crew of the vehicle 7. The acquiring unit 701 acquires the information which indicates the traveling situation of the vehicle 7 caused, for example, by the execution of the action (driving) performed by the crew including, for example, the operation of the direction indicator of the vehicle 7, the decrease in the vehicle speed, and the change of the lane, by means of the sensor 79, and the acquired information is used as the action information.

The acquiring unit 701 may extract the image of the crew from the photographed image obtained by the camera 77 for photographing the vehicle interior to acquire, as the action information, the information of, for example, the turning of the line of sight of the crew to the direction of the display apparatus 2, the pointing at the direction of the display apparatus 2 with the finger of the crew, and the time at which the action was performed. The acquiring unit 701 may acquire, as the action information, the information (voice information) which indicates the voice uttered by the crew, by the aid of the microphone 78.

Further, the acquiring unit 701 may acquire the position information (for example, latitude and longitude) of the place at which the vehicle 7 is positioned, as the action information, by the aid of the positioning device 75 such as GPS (Global Positioning System) or the like.

Note that the acquiring unit 701 is not limited to the use of the voice data and the position information as they are as the action information. For example, the judgment condition may be acquired from the advertisement control apparatus 1A to judge whether or not the voice data and/or the position information fulfill(s) the condition. The information, which indicates the judgment result, may be used as the action information.

The transmitting unit 702 transmits the action information acquired by the acquiring unit 701 to the advertisement control apparatus 1A. If the guidance information is acquired from the advertisement control apparatus 1A, the display control unit 703 displays the guidance information on the display device 76 provided in the vehicle.

FIG. 10 exemplifies functional configuration of the advertisement control apparatus 1A. The advertisement control apparatus 1A includes a condition transmitting unit 104 in addition to an acquiring unit 101, a judging unit 102, and a display control unit 103 which are the same as or equivalent to those shown in FIG. 2.

The condition transmitting unit 104 transmits the judgment condition (first judgment condition and second judgment condition) to judge whether or not the vehicle 7 is bound for the place indicated by the advertisement information, to the vehicle onboard apparatus 70.

For example, the condition transmitting unit 104 transmits, to the vehicle onboard apparatus 70, the first judgment condition of, for example, “whether or not any keyword such as ““Shop A””, ““pasta””, ““want to eat”” or the like is included in voice information” or “whether or not any keyword such as” “that's good””, ““let's go””, or ““want to eat”” is included in voice information obtained at time at which direction of display apparatus 2 is pointed with finger” by making reference to the advertisement information table.

Further, the condition transmitting unit 104 uses, as the second judgment condition, the fact that the vehicle 7 arrives at the display area which is designated as the display target by the display apparatus 2 for displaying the advertisement information, i.e., the fact that the vehicle 7 arrives at the place at which the guidance information can be seen. The second judgment condition is transmitted to the vehicle onboard apparatus 70 of the vehicle 7. In this embodiment, the map information is used as the display area ID in addition to the identification information of the camera 3. In this case, in the map information, the nodal point (junction) such as the intersection or the like is used as the node, and the road for connecting the respective nodes is used as the link. The map information has the information of, for example, the positions of the respective nodes, the shapes of the respective links, the identification information (node numbers) of the respective nodes, and the identification information (link numbers) of the respective links. For example, the advertisement information table of this embodiment stores the link numbers which indicate the respective display areas, the link numbers being correlated with the respective guidance information ID's. Then, the vehicle onboard apparatus 70 judges whether or not the vehicle 7 arrives at the road (display area) indicated by the link number. Further, the display area may be designated by the node number. In this case, the vehicle onboard apparatus 70 judges whether or not the vehicle 7 arrives at the position disposed within a predetermined distance (for example, 30 m) from the junction having the designated node number.

### (Advertisement Control Method)

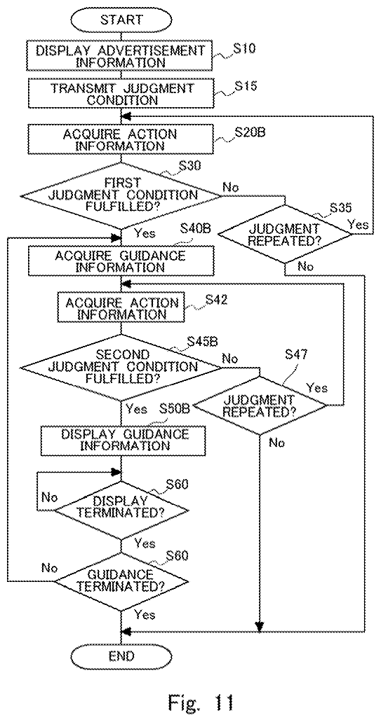

FIG. 11 shows a processing procedure of an advertisement control method executed by the advertisement control apparatus 1A in the second embodiment. In Step S10, the advertisement control apparatus 1A acquires the advertisement information from the auxiliary storage unit 13, and the advertisement information is transmitted via the communication line N to the display apparatus 2 so that the advertisement information is displayed.

In Step S15, the advertisement control apparatus 1A transmits the judgment condition (first judgment condition or second judgment condition) to judge whether or not the vehicle 7 is bound for the place indicated by the advertisement information, to the vehicle onboard apparatus 70 of the vehicle 7.

In Step S20B, the advertisement control apparatus 1A acquires the action information from the vehicle onboard apparatus 70 of the vehicle 7 traveling on the road 50. For example, the advertisement control apparatus 1A acquires, from the vehicle onboard apparatus 7, the information which indicates the direction indicated by the direction indicator of the vehicle 7, the vehicle speed of the vehicle 7, and the lane on which the vehicle 7 travels and the information which indicates the direction of the line of sight of the crew or the voice of the crew. Note that as for the vehicle 7 for which the action information cannot be acquired from the vehicle onboard apparatus 70, the image of the vehicle 7 is extracted from the photographed image obtained by the camera 3 by means of the pattern matching in the same manner as in the modified embodiment described above to acquire the information which indicates, for example, the direction indicated by the direction indicator of the vehicle 7, the traveling speed (vehicle speed) of the vehicle 7, and the lane on which the vehicle 7 travels. Further, the advertisement control apparatus 1A may acquire the action information from the photographed image obtained by the camera 3, in addition to the action information obtained from the vehicle onboard apparatus 70, for the vehicle 7 provided with the vehicle onboard apparatus 70 as well. For example, the advertisement control apparatus 1A may acquire the information of the direction indicator and the information of the vehicle speed or the like from the vehicle onboard apparatus 70, and the advertisement control apparatus 1A may acquire the information of, for example, the lane on which the vehicle 7 travels and the lane change from the photographed image obtained by the camera 3.

In Step S30, the advertisement control apparatus 1A judges whether or not the vehicle 7 is bound for the advertised place on the basis of the action information acquired in Step S20B. For example, the advertisement control apparatus 1A makes reference to the advertisement information table to find the judgment condition corresponding to the advertisement information displayed in Step S10, and the advertisement control apparatus 1A judges whether or not the traveling situation acquired in Step S20 fulfills the judgment condition. Note that if the action information acquired from the vehicle onboard apparatus 70 is the information which indicates the judgment result brought about by the vehicle onboard apparatus 70, the advertisement control apparatus 1A makes the judgment as follows. That is, if the judgment result of the vehicle onboard apparatus 70 is the affirmative judgment, the judgment result of Step S30 is also the affirmative judgment. If the judgment result of the vehicle onboard apparatus 70 is the negative judgment, the judgment result of Step S30 is also the negative judgment.

If the negative judgment is made in Step S30, the advertisement control apparatus 1A proceeds to Step S35 to judge whether or not the judgment of Step S30 is repeated. For example, if the elapsed time from the point in time at which the advertisement information was displayed in Step S10 is less than a predetermined value, and/or if the number of times of repetition of Step S30 is less than a predetermined value, then it is judged that the process of Step S30 is repeated (affirmative judgment). On the other hand, if the elapsed time is not less than the predetermined value, and/or if the number of times of repetition of Step S30 is not less than the predetermined value, then it is judged that the process of Step S30 is not repeated (negative judgment), and the process shown in FIG. 11 is terminated.

If the affirmative judgment is made in Step S30, the advertisement control apparatus 1A proceeds to Step S40B to select, in a predetermined order, one piece of the guidance information from the plurality of pieces of the guidance information corresponding to the advertisement information displayed in Step S10. The guidance information, which is specified by the guidance information ID, is acquired by reading the guidance information from the auxiliary storage unit 13.

In Step S42, the advertisement control apparatus 1A acquires the action information as the judgment result of the second judgment condition from the vehicle onboard apparatus 70 of the vehicle 7. Note that the vehicle 7, which is not provided with the vehicle onboard apparatus 70, is dealt with such that the action information is acquired from the photographed image obtained by the camera 3 in the same manner as in the modified embodiment described above.

In Step S45B, the advertisement control apparatus 1A judges whether or not the vehicle 7 arrives at the display area, i.e., whether or not the second judgment condition is fulfilled, on the basis of the action information acquired in Step S42. For example, if the judgment result is acquired from the vehicle onboard apparatus 70 in Step S42, the judgment is made in accordance with this judgment. That is, the advertisement control apparatus 1A makes the judgment as follows. If the action information (judgment result) acquired from the vehicle onboard apparatus 70 is the affirmative judgment, the judgment result of Step S45B is also the affirmative judgment. If the action information (judgment result) is the negative judgment, the judgment result of Step S45B is also the negative judgment.

Further, in the case of the vehicle 7 which is not provided with the vehicle onboard apparatus 70, the advertisement control apparatus 1A makes the judgment in the same manner as in Step S45 shown in FIG. 7. For example, the roads 50D to 50H, which are designated as the display targets by the display apparatuses 2D to 2H, are photographed by the cameras 3D to 3H. If the image of the same vehicle 7 as the vehicle 7 judged to be bound for the advertised place in Step S30 is extracted from the photographed image, it is judged that the vehicle 7 arrives at the road which is designated as the display target (affirmative judgment). On the other hand, if the image of the same vehicle 7 is not extracted, it is judged that the vehicle 7 does not arrive at the road which is designated as the display target (negative judgment).

If the negative judgment is made in Step S45B, the advertisement control apparatus 1A proceeds to Step S47 to judge whether or not the judgment of Step S45B is repeated. For example, if the elapsed time from the point in time of the acquisition of the guidance information in Step S40 is less than a predetermined value, and/or if the number of times of repetition of Step S30 is less than a predetermined value, then it is judged that the process of Step S45 is repeated (affirmative judgment). On the other hand, if the elapsed time is not less than the predetermined value, and/or if the number of times of repetition of Step S45 is not less than the predetermined value, then it is judged that the process of Step S45 is not repeated (negative judgment), and the process shown in FIG. 11 is terminated.

On the other hand, if the affirmative judgment is made in Step S45, then the advertisement control apparatus 1A proceeds to Step S50B, and the guidance information acquired in Step S40 is transmitted to the display apparatus 2 and the vehicle onboard apparatus 70 so that the guidance information is displayed. The processes of Steps S60 and S70 are the same as the processes shown in FIG. 7 described above.

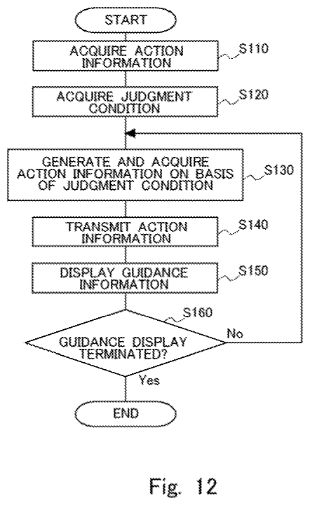

FIG. 12 shows a processing procedure of an advertisement control method executed by the vehicle onboard apparatus 70 in the second embodiment.

In Step S110, the vehicle onboard apparatus 70 acquires, for example, the information of the direction indicator and the information of the vehicle speed as the action information by the aid of the sensor 79.

In Step S120, the vehicle onboard apparatus 70 acquires the judgment condition (first judgment condition and second judgment condition) transmitted in Step S15 shown in FIG. 11 by the advertisement control apparatus 1A.

In Step S130, the vehicle onboard apparatus 70 performs the judgment on the basis of the judgment condition acquired in Step S120 to generate the action information which includes the judgment result. For example, the vehicle onboard apparatus 70 judges whether or not the photographed image photographed by the camera 77 and the voice information acquired by the microphone 78 fulfill the condition on the basis of the first judgment condition acquired in Step S120. For example, the judgment result, the identification information of the judgment condition, and the judgment time are used as the action information. Specifically, the judgment is made to judge “whether or not any keyword such as ““Shop A””, ““pasta””, ““want to eat”” or the like is included in voice information”, “whether or not line of sight of crew is directed to direction of display apparatus 2 by not less than predetermined time” or “whether or not any keyword such as ““that's good””, ““let's go””, or ““want to eat”” is included in voice information obtained at time at which direction of display apparatus 2 is pointed with finger”. The action information, which includes the judgment result, is generated.

Further, the vehicle onboard apparatus 70 judges whether or not the position of the subject vehicle 7 acquired from the positioning device 75 arrives at the display area on the basis of the second judgment condition acquired in Step S120. For example, the judgment result, the identification information of the judgment condition, and the judgment time are used as the action information.

In Step S140, the vehicle onboard apparatus 70 transmits the action information acquired in Step S110 and the action information generated in Step S130 to the advertisement control apparatus 1A.

In Step S150, the vehicle onboard apparatus 70 receives the guidance information transmitted in Step S50B shown in FIG. 11 by the advertisement control apparatus 1A, and the guidance information is displayed on the display apparatus 76.

In Step S160, the vehicle onboard apparatus 70 judges whether or not the display of the guidance information is terminated. For example, the vehicle onboard apparatus 70 makes the affirmative judgment if all of the guidance information corresponding to the judgment condition acquired in Step S120 is displayed, and the process shown in FIG. 12 is terminated.

If the negative judgment is made in Step S160, then the vehicle onboard apparatus 70 returns to Step S130, and it is judged whether or not the vehicle 7 arrives at the next display area to generate the action information. On the other hand, if the affirmative judgment is made in Step S160, the vehicle onboard apparatus 70 terminates the process shown in FIG. 12.

As described above, according to this embodiment, the guidance information can be successively displayed depending on the traveling position of the vehicle 7. It is possible to make the guidance comprehensively to the advertised place, for example, in the same manner as in FIG. 6. Therefore, even if the vehicle onboard apparatus 7 is not provided with any navigation function, then the guidance information can be displayed on the display device 76 of the vehicle onboard apparatus 70, and the crew of the vehicle 7 can easily drive until arrival at the advertised place. Further, even if the vehicle onboard apparatus 70 is provided with any navigation function, the crew of the vehicle 7 can easily drive until arrival at the advertised place, without consuming any time and labor which would be otherwise required such that the vehicle 7 should stop to set the destination.

Note that in this embodiment, those other than the configuration to acquire the action information of the crew from the vehicle onboard apparatus 70 are the same as or equivalent to those of the modified embodiment described above. However, it is also allowable that those other than the concerning configuration are the same as or equivalent to those of the first embodiment. That is, it is also allowable to adopt such configuration that one piece of the guidance information is provided for one piece of the advertisement information.

### Other Embodiments

The embodiments described above are exemplified by way of example in every sense. The present disclosure may be carried out while appropriately making changes within a range without deviating from the gist or essential characteristics thereof.

Further, the configuration and the processes explained in this disclosure can be carried out while freely combining them unless any technical contradiction or inconsistency arises.

Further, the process, which has been explained as being performed by one apparatus or device, may be executed by a plurality of apparatuses or devices in a shared manner. Alternatively, the process, which has been explained as being performed by the different apparatuses or devices, may be executed by one apparatus or device without causing any problem. In the computer system, it is possible to flexibly change the way of realization of the respective functions by means of any hardware configuration (server configuration).

The present disclosure can be also realized such that a computer program, in which the functions explained in the foregoing embodiments are packaged, is supplied to a computer, and the program is read and executed by one or more processors possessed by the computer. The computer program as described above may be provided for the computer by means of any non-transitory computer-readable storage medium capable of being connected to a system bus of the computer, or the computer program may be provided for the computer by the aid of a network. The non-transitory computer-readable storage medium includes, for example, disks of arbitrary types such as magnetic disk (floppy (registered trademark) disk, hard disk drive (HDD) and the like), optical disk (CD-ROM, DVD disk, Blu-ray Disc and the like) and the like, read only memory (ROM), random access memory (RAM), EPROM, EEPROM, magnetic card, flash memory, optical card, and media of arbitrary types suitable for storing electronic commands.

What is claimed is:

1. An advertisement control apparatus comprising a controller which executes:
display of advertisement information on a display apparatus installed with a display surface directed to a road;
acquisition of action information which exhibits an action performed by a crew of a vehicle traveling on the road;
judgment to judge whether or not the vehicle is bound for a place indicated by the advertisement information on the basis of the action information; and
display of guidance information of the place indicated by the advertisement information on the display apparatus or any display apparatus different from the display apparatus if it is judged that the vehicle is bound for the place indicated by the advertisement information.

2. The advertisement control apparatus according to claim 1, wherein the action information is information which indicates a direction indicated by a direction indicator of the vehicle, a vehicle speed of the vehicle, and/or a lane on which the vehicle travels, or information which indicates a direction of a line of sight of the crew or a voice of the crew.

3. The advertisement control apparatus according to claim 2, wherein if the controller acquires the direction indicated by the direction indicator of the vehicle as the action information, and the direction indicated by the direction indicator is coincident with a direction directed from the vehicle to the place indicated by the advertisement information, then the controller judges that the vehicle is bound for the place indicated by the advertisement information, and the guidance information is displayed to indicate a route from a position of the vehicle to the place indicated by the advertisement information.

4. The advertisement control apparatus according to claim 1, wherein a display area is defined for every piece of the guidance information, and the controller allows the guidance information to be displayed on the display apparatus existing in the display area of the guidance information.

5. The advertisement control apparatus according to claim 4, wherein:
a plurality of the display areas of the guidance information are set while allowing the areas to be different from each other on a route from the display area of the advertisement information to the place indicated by the advertisement information; and
if the controller acquires position information of the vehicle as the action information, and the controller judges that the vehicle arrives at the display area, then the guidance information, which is set for the display area, is displayed on the display apparatus for which the display area is designated as a display target.

6. An advertisement system comprising an advertisement control apparatus which displays advertisement information on a display apparatus installed with a display surface directed to a road, and a terminal which is provided in a vehicle traveling on the road; the terminal including a controller which executes:
acquisition of action information which exhibits an action performed by a crew of the vehicle; and
transmission of the action information to the advertisement control apparatus; and the advertisement control apparatus including a controller which executes:
display of the advertisement information on the display apparatus;
acquisition of the action information from the terminal;
judgment to judge whether or not the vehicle is bound for a place indicated by the advertisement information on the basis of the action information; and
display of guidance information of the place indicated by the advertisement information on the display apparatus or any display apparatus different from the display apparatus if it is judged that the vehicle is bound for the place indicated by the advertisement information.

7. The advertisement system according to claim 6, wherein:
the terminal includes a display device; and
the controller of the advertisement control apparatus transmits the guidance information to the terminal, and thus the guidance information is displayed on the display device of the terminal.

8. An advertisement control method for allowing a controller to execute:
display of advertisement information on a display apparatus installed with a display surface directed to a road;
acquisition of action information which exhibits an action performed by a crew of a vehicle traveling on the road;
judgment to judge whether or not the vehicle is bound for a place indicated by the advertisement information on the basis of the action information; and
display of guidance information of the place indicated by the advertisement information on the display apparatus or any display apparatus different from the display apparatus if it is judged that the vehicle is bound for the place indicated by the advertisement information.
